(19) United States
(12) Patent Application Publication
(10) Pub. No.: US 2006/0062371 A1
(43) Pub. Date: Mar. 23, 2006

(54) Method and apparatus for associating an alternate access device with a telephone

(76) Inventors: Gregg C. Vanderheiden, Madison, WI (US); Thomas Y. Yen, Fitchburg, WI (US)

Correspondence Address: QUARLES & BRADY LLP, 411 E. WISCONSIN AVENUE, SUITE 2040, MILWAUKEE, WI, 53202-4497, US

(21) Appl. No.: 10/947,737

(22) Filed: Sep. 23, 2004

(51) Int. Cl. H04M 3/42

(52) U.S. Cl. 379/211.02

(57) ABSTRACT

A method includes establishing a first communication link between a telephone having a plurality of input/output functions and a target device. An alternate access device is associated with the telephone. At least one of the input/output functions is transferred to the alternate access device. A second communication link is established between the target device and the alternate access device. Data associated with input/output functions not transferred to the alternate access device is communicated over the first communication link. Data associated with the transferred input/output function is communicated over the second communication link.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates generally to the field of telecommunications, and more particularly to associating an alternate access device with a telephone.

Modern office telephone systems offer users with a wide variety of functions including voice mail, call-forwarding, call transferring, conferencing, caller ID, etc. In many offices, a private branch exchange (PBX) system is employed for sharing a fixed number of connections with the conventional public switched telephone network (PSTN). A telephone server provides the interface between the users and the outside phone network. Many of the services provided by the phone system are programmed into either the telephone server or the user's phone. A typical office telephone includes one or more programmable buttons to which the user can assign functions, such as conferencing, transferring, message retrieval, speed dial, etc. Other buttons, referred to as soft keys have functions that change depending on the actions of the user and/or the state of the call. For example, if a call is active, a soft key may be used to implement a call transfer. If no call is active, the same button may be used to access a menu for the phone or directory of contacts. The programmable nature of a PBX system increases the flexibility of the system, but in some respects, also increases the complexity of the system.

Individual phones are connected to the PBX network and registered with the telephone server, which provides security services. Different phones and/or users may have different security profiles, such as restrictions on access to long distance services. If an unidentified telephone is connected to the telephone network, the telephone server typically does not recognize the telephone or allow PBX access. Also, if a phone is moved from one subnet on a network to another location on a different subnet, re-registration may be required.

These aspects of office phone systems give rise to obstacles for users that have special requirements or preferences for telephone services. For example, a hearing impaired user may require a specialized telecommunication device for the deaf (TDD), also known as a text telephone (TTY). Because of the security restrictions on the network, the user may not be able to easily connect their text telephone (i.e., even if the telephone is packet-compatible) to a network without registration, thus hampering the user. A visually impaired user may have difficulty with the keypads of the telephone. While the user may be able to memorize the locations of the buttons with fixed functions, it is not possible to memorize the functions of the soft keys that change frequently based on call context. Moreover, a variety of telephone models, each with different keypad layouts, may be used throughout a facility. Individuals with physical limitations may also be affected by the structure of the telephone system. A person with low vision may need a larger display. Some users may require a specialized input device, such as an oversized keypad, communication board, or pointing device to interface with a telephone. The difficulties described above apply to visitors to an office as well as the employees. A visitor with a text telephone may not be able to readily connect it to the telephone system.

These restrictions on users that have specialized needs for accessing a telephone system tend to hamper their effectiveness in an organization, because it may be difficult for some individuals to interact outside their offices equipped with assistive devices. However, from a network standpoint it is still necessary to maintain security measures to prevent misuse or unauthorized use of the telephone system. Hence, it is difficult to accommodate the needs of users with special requirements or preferences for telephone services.

The present invention is directed to overcoming, or at least reducing the effects of, one or more of the problems set forth above.

### BRIEF SUMMARY OF THE INVENTION

Certain aspects commensurate in scope with the invention originally claimed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

It has been realized that users with special requirements or preferences for telephone services may be accommodated without reducing the efficacy of network security by allowing a user to associate an alternate access device to a telephone on the telephone network and transfer at least one input/output function of the telephone to the alternate access device.

Consistent with the above realizations, in at least some embodiments, one aspect of the present invention is seen in a method that includes establishing a first communication link between a telephone having a plurality of input/output functions and a target device. An alternate access device is associated with the telephone. At least one of the input/output functions is transferred to the alternate access device. A second communication link is established between the target device and the alternate access device. Data associated with input/output functions not transferred to the alternate access device is communicated over the first communication link. Data associated with the transferred input/output function is communicated over the second communication link.

Another aspect of the present invention is seen in a communication system including a target device, an alternate access device, and a telephone. The telephone has a plurality of input/output functions and is operable to transfer at least one of the input/output functions to the alternate access device. The telephone is operable to communicate data associated with input/output functions not transferred to the alternate access device over a first communication link to the target device. The target device is operable to communicate data associated with the transferred input/output function over a second communication link to the alternate access device.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

The invention may be understood by reference to the following description taken in conjunction with the accompanying drawings, in which like reference numerals identify like elements, and in which:

FIG. 1 is a simplified block diagram of a communication system in accordance with one illustrative embodiment of the present invention;

FIGS. 2-4 are simplified block diagrams illustrating techniques for implementing communication links between entities in the communication system of FIG. 1 and an alternate access device; and

FIG. 5 is a simplified flow diagram of a method for associating an alternate access device with a telephone in accordance with another illustrative embodiment of the present invention.

### DETAILED DESCRIPTION OF THE INVENTION

While the present invention may be embodied in any of several different forms, the present invention is described here with the understanding that the present disclosure is to be considered as setting forth an exemplification of the present invention which is not intended to limit the invention to the specific embodiment(s) illustrated.

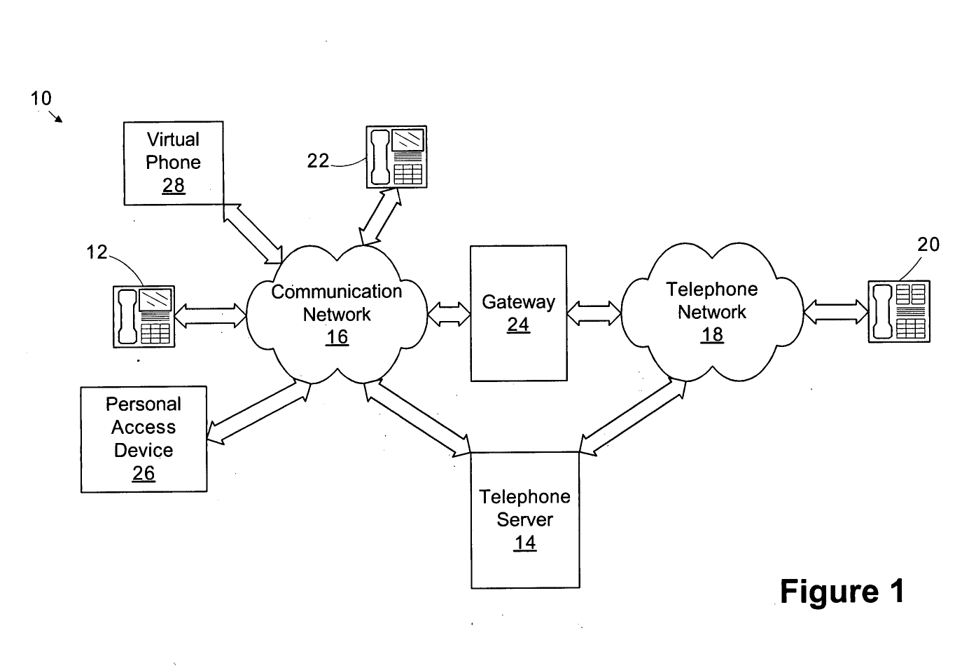

Referring now to FIG. 1, a simplified block diagram of a communication system 10 is shown. A telephone 12 is provided for connecting to a telephone server 14 over a communication network 16. For example, the communication network 16 may be a packet-based network (e.g., an internet protocol (IP) network), and the telephone 12 may also use a packet-based protocol for communication. One embodiment of packet-based telephony is commonly referred to as voice over internet protocol (VOIP) telephony. Packet-based telephony may be implemented on the internet or some other communication network, such as a local area network, wide area network, cellular network, etc.

The telephone server 14 may function as a gateway to interface with a telephone network 18, such as the public switched telephone network (PSTN) or a private branch exchange (PBX). A user of the telephone may establish a connection with a conventional telephone 20 connected to the telephone network 18 or with another VOIP telephone 22 located on the communication network 16. In some embodiments, the telephone server 14 may not function as a gateway, and a separate gateway 24 may be provided. The telephone server 14 may interact with the telephone 12 and the gateway 24 to establish a connection therebetween to facilitate communication between the telephone 12 and the conventional telephone 20.

The telephone 12 may be implemented as a stand-alone device or as a software application executing on a computer system, such as a desktop computer, notebook computer, personal data assistant, etc. The communication network 16 may employ hard-wired (e.g., Ethernet) or wireless (e.g. 802.11) connections. Numerous industry standards relating to IP telephony have been promulgated and are publicly available.

In accordance with the present invention, a user may associate an alternate access device 26 with the telephone 12 to transfer selected I/O functions normally associated with the telephone 12 to the alternate access device 26. For example, the alternate access device 26 may be an alternate display, an alternate keypad, an alternative speaker, an alternative microphone, an assistive device for a handicapped individual, etc. After such association, the user may interface with the alternate access device 26 instead of the telephone 12 for the transferred I/O functionality, as will be described in greater detail below. The specific manner in which the I/O functionality is transferred and thereafter managed depends on the particular implementation. As will be discussed in greater detail below, there are various ways by which the user may associate the alternate access device 26 and the telephone 12. The user of the telephone 12 may associate the alternate access device 26 with the telephone 12 prior to placing the call or during the call. In some instances a virtual phone 28 may be implemented by the telephone 12 or the telephone server 14 to coordinate communication between the telephone 12, the alternate access device 26, and the remote telephone 20, 22.

Transferring one or more I/O functions to the alternate access device 26 does not preclude allowing the telephone 12 to still provide part or all of the I/O function in parallel with the alternate access device 26. For example, if a display function is transferred to the alternate access device 26, the display data may also be provided to the telephone 12. If a keypad function is transferred, the telephone 12 may still accept keypad inputs.

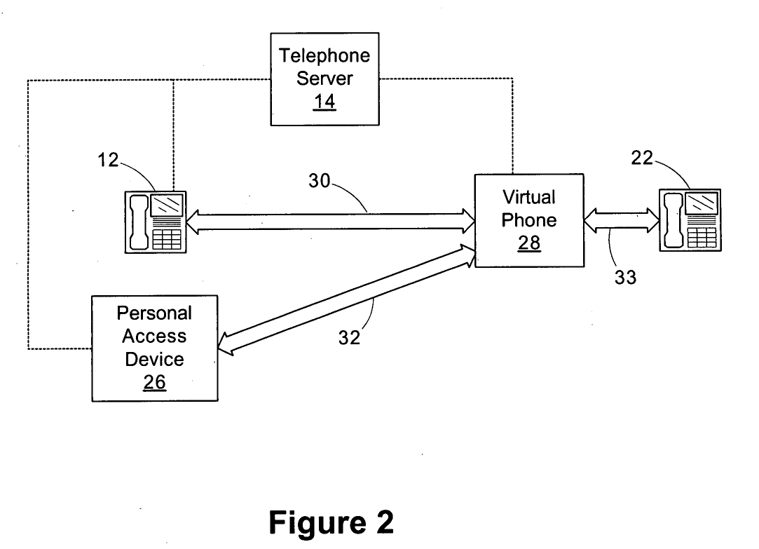

Exemplary techniques for establishing initial connections between the telephone 12 and remote devices, such as the conventional telephone 20 and VOIP telephone 22 are described below in reference to FIGS. 2-4. In general, separate communication links are established between the telephone 12, the alternate access device 26 and a target device. The target device may not be the actual device at the other end of the telephone call, but in some case, may be an intermediary device that coordinates the communication of the transferred I/O functionality between the alternate access device 26 and the final target. In the context of FIG. 1, the target device may be the telephone server 14, the VOIP telephone 22, the gateway 24, or the virtual telephone 28.

In the example of FIG. 2, the telephone 12 communicates with the VOIP telephone 22. The telephone 12 contacts the telephone server 14 with the address of the VOIP telephone 22. The telephone 12 or the telephone server 14 may instantiate a virtual telephone 28 (e.g., software application) that serves as an intermediary between the telephones 12, 22. Although the virtual telephone 28 is illustrated as a separate entity, its functionality may be integrated into the software of the telephone 12 or the telephone server 14.

A first communication link 30 is established between the telephone 12 and the virtual telephone 28. An alternative I/O communication link 32 may be established between the virtual telephone 28 and the alternate access device 26. I/O data for the transferred I/O functionality is communicated over the alternative I/O communication link 32 directly with the alternate access device 26. A communication link 33 may be established between the virtual telephone 28 and the VOIP telephone 22.

If the association is performed during the call initiation process, the virtual telephone 28 may be instantiated immediately and the communication links 30, 32 may be established prior to the telephone server 14 contacting the telephone 22 to establish the communication link 33. In the case where the telephone 12 is responsible for executing the virtual telephone 28, the telephone server 14 may only see a request from the virtual telephone 28 to connect to the VOIP telephone 22.

If the association occurs during the call, the initial communication link 30 may be directly between the telephone 12 and the VOIP telephone 22. Upon initiating the association, the telephone 12 or the telephone server 14 executes the virtual telephone 28, transfers the communication link 30 to the virtual telephone 28, and established the alternative I/O communication link 32 between the alternate access device 26 and the virtual telephone 28 and the communication link 33 between the virtual telephone 28 and the VOIP telephone 22.

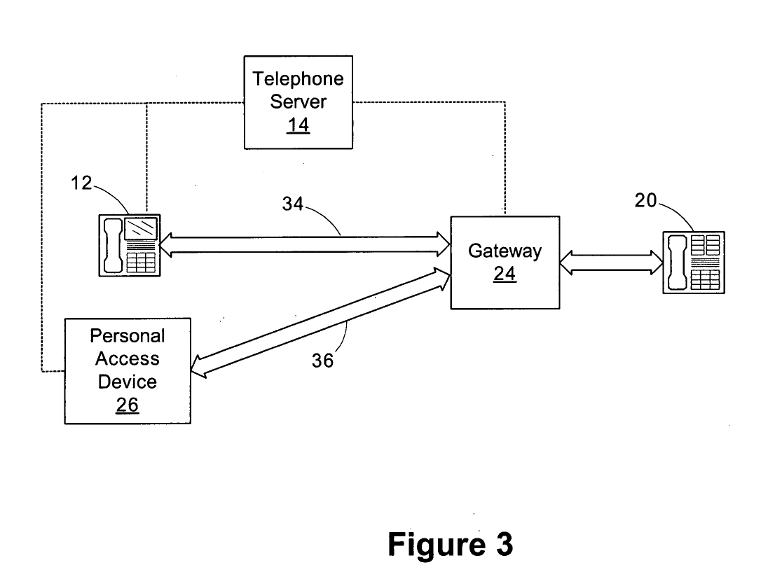

In the example of FIG. 3, a connection between the telephone 12 and the conventional telephone 20 is established through the gateway 24. The telephone server 14 negotiates a communication link 34 between the telephone 12 and the gateway 24. After the communication link 34 is established, the telephone server 14 is no longer involved in the communication and the telephone 12 and the gateway 24 communicate directly. If the user associates the alternate access device 26 with the telephone 12 prior to placing the call, the telephone server 14 may negotiate an alternative I/O communication link 36 between the gateway 24 and the alternate access device 26 during the call initiation process. I/O data for the transferred I/O functionality is communicated over the alternative I/O communication link 36 directly with the alternate access device 26. If the user associates the alternate access device 26 during the call, the telephone 12 may contact the telephone server 14 to set up the alternative I/O communication link 36 with the gateway 24. Alternatively, the telephone 12 may direct the gateway 24 to initiate the alternative I/O communication link 36 and, thereafter, communicate the I/O data for the transferred I/O functionality directly with the alternate access device 26. Although not illustrated, the virtual telephone 28 may be instantiated by the telephone 12, the telephone server 14, or the gateway 24, as described above, to act as an intermediary between the telephone 12, the alternate access device 26, and the gateway 24.

Although the telephone server 14 is illustrated as not being involved in the communication link 34 and the alternative I/O communication link 36 after they are initiated, in some cases, it may be desirable for security purposes to keep the telephone server 14 involved in the links 34, 36. The telephone server 14 may then act as a relay between the telephone 12 and the gateway 24.

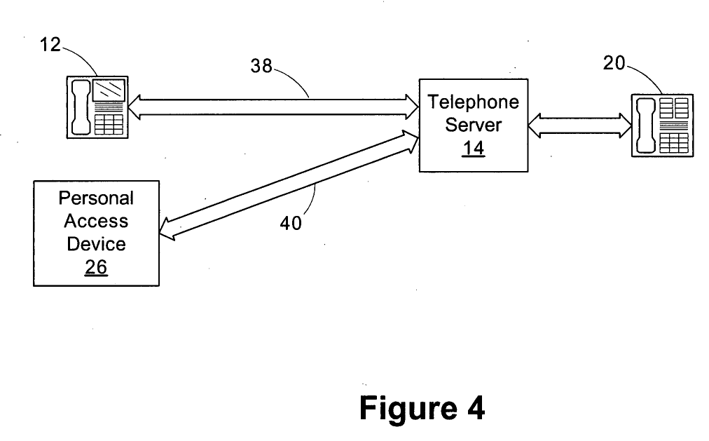

In the example of FIG. 4, the telephone server 14 functions as a gateway to interface with the telephone network 18 (see FIG. 1). A connection between the telephone 12 and the conventional telephone 20 is established through the telephone server 14. A communication link 38 is established between the telephone 12 and the telephone server 14. The telephone server 14 contacts the conventional telephone 20 to complete the connection, but remains involved with the communication link 38. If the user associates the alternate access device 26 with the telephone 12 prior to placing the call, the telephone server 14 may negotiate an alternative I/O communication link 40 between itself and the alternate access device 26 during the call initiation process. I/O data for the transferred I/O functionality is communicated over the alternative I/O communication link 40 directly with the alternate access device 26. If the user associates the alternate access device 26 during the call, the telephone 12 may contact the telephone server 14 to set up the alternative I/O communication link 40. In the case where a virtual telephone 28 is used, the telephone server 14. Although not illustrated, the virtual telephone 28 may be instantiated by the telephone 12 or the telephone server 14, as described above, to act as an intermediary between the telephone 12, the alternate access device 26, and the telephone server 14.

There are various types of alternate access devices 26 that may be employed. In one embodiment, the alternate access device 26 may be a display device. At least a portion of the text or other display data normally displayed on the display of the telephone 12 is routed to the alternate access device 26. Some or all of the display data may also be displayed on the telephone 12. This function may be useful for an individual who has difficulty reading characters on a typical display screen. The alternate access device 26 may display the text or other data in a magnified form. In a situation where the user has impaired vision, the alternate access device 26 may convert the display data into a voice signal that the user may hear rather than view. The alternate access device 26 may also be a Braille output device that converts the display data into Braille characters that may be touched by the user. For a user with hearing impairments, the alternate access device 26 may display sign language symbols in lieu of or in conjunction with text data.

In another embodiment, the alternate access device 26 may be an alternative keypad. The terms keypad and keyboard are considered to be synonymous. Hence, an alternate keypad may be an alphanumeric keyboard of a computing device. The user may have difficulty using a keypad due to physical or sight limitations. A user with impaired vision may not easily memorize key locations on the telephone 12, because many phone configurations are available. Also, the functionality of some keys is controlled by software, and may change depending on the actions of the user. Prior to a call, the soft key may be programmed to access a contact list. During a call, the same soft key may be programmed to transfer the call. The alternate access device 26 may accommodate the user in accordance with their particular limitations. For example, instead of using the keypad, the user may use a touch screen or voice input device that translates the user's inputs to keypad data. In such a manner, the user need only become familiar with one device for inputting keypad data. Another advantage to transferring the keypad function is for entering text data. Typically telephone keypads allow users to enter text by pressing the 1-9 digit keys multiple times. For example, the letters “D,” “E,” and “F” are typically associated with the “3” digit key. If the user wants to enter the letter “F,” the “3” key is pressed three times in a short time interval. This technique is cumbersome for entering anything but short words or phrases. By associating the keypad function to an alternate access device 26 with a standard keyboard, the ease of entering text data can be increased. Not all keypad functions need be transferred. For example, numeric key functions may be implemented on the telephone 12 and alphabetic key functions may be transferred to the alternate access device 26.

Another exemplary embodiment of the alternate access device 26 is an alternate audio device. The user may wish that the voice signal normally provided on the telephone headset or speaker be communicated to a headphones or an alternative speaker.

In some embodiments, multiple I/O functions may be transferred to the alternate access device 26. For example, the display and keypad functions may be transferred. Of course, other combinations of I/O functions may also be transferred.

Although applications have been described that allow users with disabilities to more readily use the telephone 12 through the association with the alternate access device 26, the invention is not so limited, and many other advantages exist. For example, not all telephones in a facility may be equipped with speakerphone capability. The alternate access device 26 may function as a portable speakerphone that may be used in conjunction with other non-equipped telephones. The audio and microphone I/O functions of the telephone 12 may be transferred to the alternate access device 26. Accordingly, users in the room could hear the conversation and respond accordingly. The alternate access device 26 could be moved to different locations in the facility when speakerphone functionality is desired. In another example, the I/O functions may be transferred to the alternate access device 26 for convenience. If a user is working on a notebook or desktop computer that is not within easy reach of the telephone, one or more of the I/O functions may be transferred to allow the user to interface with the computer instead of the telephone 12.

There are various techniques that may be used to facilitate the association of the alternate access device 26 with the telephone 12. Specific implementations may differ depending on the level of security desired. The alternate access device 26 may communicate over the communication network 16 using a wireless (e.g., 802.11) connection or a hardwired connection (e.g., a port on the telephone 12 or a network port). The alternate access device 26 would inherit the access rights profile on the communication network 16 associated with the telephone 12. Hence, if the telephone 12 was restricted against placing long distance phone calls, the alternate access device 26 would also be so restricted.

In one illustrative example, the user enters an identifying address of the alternate access device 26 on the keypad of the telephone 12. For example, a media access control (MAC) address uniquely identifies a particular hardware device. In some cases, the rights of the alternate access device 26 may be limited for security purposes. Another address that may be used to identify the alternate access device 26 is an IP address assigned to the device (i.e., fixed or dynamic) for accessing the communication network 16 or a uniform resource locator (URL) representing the P address. However, if the alternate access device 26 were to be recognized as a full member on the communication network 16 it may interface with other entities on the network, such as storage devices, servers, etc., in a manner that would compromise security. By using a different address, such as the MAC address, the rights of the alternate access device 26 on the communication network 16 can be limited. For example, the telephone server 14 may only allow the alternate access device 26 to communicate data with the target device for the call (e.g., the virtual telephone 28 in the embodiment of FIG. 2, the gateway 24 in the embodiment of FIG. 3, or the telephone server 14 in the embodiment of FIG. 4). The alternate access device 26 may use a different protocol than the typical IP protocol used on the network to limit its access to IP devices other than the intended target device.

To execute the association, the user would enter the address of the alternate access device 26 followed by a code indicating which I/O functions to associate with the alternate access device 26. The following table illustrates exemplary digit codes that may be assigned to the various I/O functions. Of course, other codes may be used.

TABLE 1
Digit Code for Transferring I/O Functions

| Digit | I/O Function Transferred |
|---|---|
| 1 | Display Output |
| 2 | Text Messaging Display Output |
| 3 | Keypad Entry Input |
| 4 | All I/O Functions |
| 5 | Audio Output |
| 6 | Microphone Input |
| 7 | Videophone/Camera Output |
| 8 | Videophone/Camera Input |

If the user wishes to transfer more than one I/O function multiple digits may be entered. For example, the transfer the display output and the keypad input functions, the user may enter {ADDRESS}{13}.

Additional security measures may be employed to enhance the security of the association process. For example, if the alternate access device 26 associates through the telephone 12, a signal strength parameter may be verified to determine that the alternate access device 26 is close to the telephone 12. If the alternate access device 26 access the communication network 16 using a hardwired connection, it may be restricted to connecting only using a network port on the telephone 12 or a network port in the same room. Proximity verification reduces the likelihood that the I/O functions could be transferred for non-legitimate purposes (e.g., eavesdropping or placing unauthorized long distance calls).

In another embodiment, the user may input an address associated with the telephone 12 on the alternate access device 26 and send a request the telephone server 14 to associate the telephone 12 with the alternate access device 26. To verify proximity in such a case, the user may be required to also enter a code provided by the telephone server 14 and displayed on the display of the telephone 12. In another embodiment, radio frequency ID (RFID) codes may be communicated between the telephone 12 and the alternate access device 26.

In some embodiments, the telephone 12 may display a warning, such as a flashing light, a message on its display, or an audible signal, indicating that one or more of its I/O functions have been transferred to the alternate access device 26. If the individual that normally uses the phone does not expect this transferred state (i.e., non-legitimate access), appropriate actions may be taken to disconnect the alternate access device 26.

Security may also be enhanced by limiting the duration of the association between the alternate access device 26 and the telephone 12. For example, the association may be limited to one call. After the call, the association may be cancelled, and the telephone 12 may revert to its default state, with no I/O functions transferred. Also, different locations in a facility may have different association capabilities. For example, telephones in executive offices or sensitive areas of a facility may not allow association at all, or may require additional authentication steps. The user may have to enter a password or other security key in addition to the identifier of the alternate access device 26.

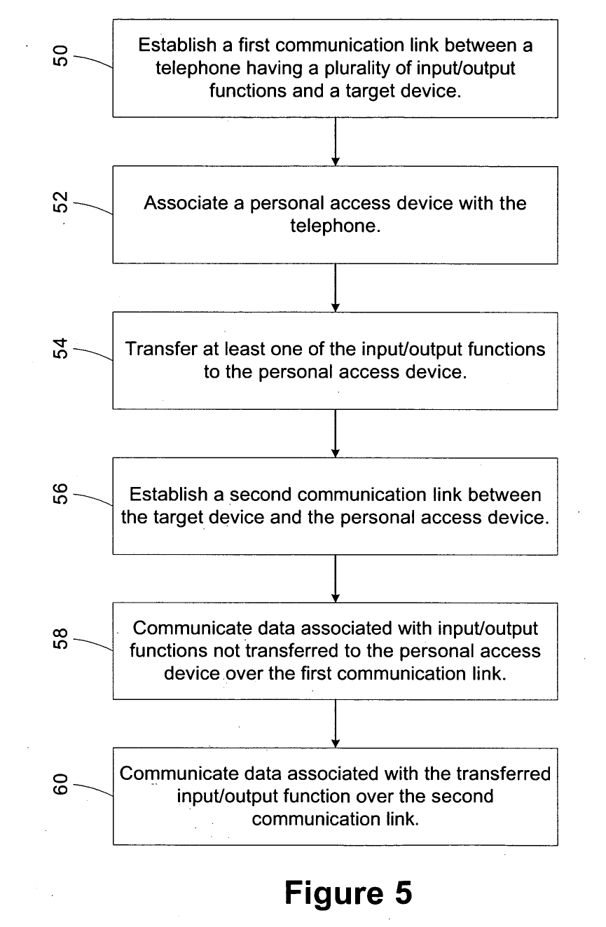

Turning now to FIG. 5, a simplified flow diagram of a method for associating an alternate access device 26 with a telephone 12 in accordance with another illustrative embodiment of the present invention is provided. In block 50, a first communication link is established between a telephone having a plurality of input/output functions and a target device. The target device may vary depending on the particular implementation. In the example of FIG. 2, the target device may be the telephone server 14, the VOIP telephone 22, or the virtual telephone 28. In the example, of FIG. 3, the target device may be the gateway 24 or the telephone server 14 if it acts an intermediary. In the example of FIG. 4, the target device may be the telephone server 14. In block 52, an alternate access device is associated with the telephone. In block 54, at least one of the input/output functions is transferred to the alternate access device. In block 56, a second communication link is established between the target device and the alternate access device. In block 58, data associated with input/output functions not transferred to the alternate access device is communicated over the first communication link. In block 60, data associated with the transferred input/output function is communicated over the second communication link.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method, comprising:
establishing a first communication link between a telephone having a plurality of input/output functions and a target device;
associating an alternate access device with the telephone;
transferring at least one of the input/output functions to the alternate access device;
establishing a second communication link between the target device and the alternate access device;
communicating data associated with input/output functions not transferred to the alternate access device over the first communication link; and
communicating data associated with the transferred input/output function over the second communication link.

2. The method of claim 1, wherein associating the alternate access device with the telephone further comprises associating the alternate access device with the telephone prior to establishing the first communication link.

3. The method of claim 1, wherein associating the alternate access device with the telephone further comprises associating the alternate access device with the telephone after establishing the first communication link.

4. The method of claim 1, further comprising terminating the association between the alternate access device and the telephone responsive to terminating the first communication link.

5. The method of claim 1, further comprising transferring a plurality of the input/output functions to the alternate access device.

6. The method of claim 5, further comprising retaining at least one of the input/output functions on the telephone.

7. The method of claim 1, wherein the alternate access device comprises a display device, and transferring the at least one of the input/output functions to the alternate access device further comprises transferring a display function of the telephone to the alternate access device.

8. The method of claim 1, wherein the alternate access device comprises a keypad, and transferring the at least one of the input/output functions to the alternate access device further comprises transferring a keypad function of the telephone to the alternate access device.

9. The method of claim 1, wherein the alternate access device comprises a speaker, and transferring the at least one of the input/output functions to the alternate access device further comprises transferring an audio function of the telephone to the alternate access device.

10. The method of claim 1, wherein the alternate access device comprises a microphone, and transferring the at least one of the input/output functions to the alternate access device further comprises transferring a microphone function of the telephone to the alternate access device.

11. The method of claim 1, wherein the alternate access device comprises a video camera, and transferring the at least one of the input/output functions to the alternate access device further comprises transferring a video camera function of the telephone to the alternate access device.

12. The method of claim 1, wherein the target device comprises an internet protocol phone, and establishing the first communication link further comprises establishing the first communication link over a communication network to the internet protocol phone.

13. The method of claim 1, wherein target device comprises a telephone server, and establishing the first and second communication links further comprises establishing the first and second communication links over a communication network to the telephone server.

14. The method of claim 13, further comprising establishing a third communication link between the telephone server and a remote telephone.

15. The method of claim 1, wherein target device comprises a gateway, and establishing the first and second communication links further comprises establishing the first and second communication links over a communication network to the gateway.

16. The method of claim 15, further comprising establishing a third communication link between the gateway and a remote telephone.

17. The method of claim 1, wherein associating the alternate access device with the telephone further comprises receiving an address of the alternate access device on an input device of the telephone.

18. The method of claim 1, wherein associating the alternate access device with the telephone further comprises receiving an address of the telephone on an input device of the alternate access device.

19. The method of claim 18, further comprising:
providing a confirmation code via the telephone; and
receiving the confirmation code on an input device of the alternate access device.

20. The method of claim 1, wherein associating the alternate access device with the telephone further comprises verifying proximity of the telephone and the alternate access device.

21. The method of claim 1, further comprising providing an indication on the telephone responsive to transferring the at least one input/output function to the alternate access device.

22. The method of claim 21, wherein providing the indication comprises providing at least one of a visual indication and an audio indication.

23. The method of claim 1, further comprising restricting the alternate access device according to an access rights profile of the telephone.

24. The method of claim 1, wherein target device comprises a virtual telephone, and establishing the first and second communication links further comprises establishing the first and second communication links with the virtual telephone.

25. The method of claim 24, further comprising establishing a third communication link between the virtual telephone and a remote telephone.

26. The method of claim 1, further comprising communicating data associated with the transferred input/output function over both the first and second communication links.

27. The method of claim 1, wherein communicating over the first communication link comprises communicating using a first protocol, and communicating over the second communication link comprise communicating using a second protocol different than the first protocol.

28. A communication system, comprising:
a target device;
an alternate access device; and
a telephone having a plurality of input/output functions and being operable to transfer at least one of the input/output functions to the alternate access device and communicate data associated with input/output functions not transferred to the alternate access device over a first communication link to the target device, wherein the target device is operable to communicate data associated with the transferred input/output function over a second communication link to the alternate access device.

29. The system of claim 28, wherein the telephone is operable to transfer the at least one input/output function prior to establishing the first communication link with the target device.

30. The system of claim 28, wherein the telephone is operable to transfer the at least one input/output function after establishing the first communication link with the target device.

31. The system of claim 28, wherein the telephone is further operable to terminate the transfer of the at least one input/output function responsive to a termination of the first communication link.

32. The system of claim 28, wherein the telephone is further operable to transfer a plurality of the input/output functions to the alternate access device.

33. The system of claim 32, wherein the telephone is further operable to retain at least one of the input/output functions.

34. The system of claim 28, wherein the alternate access device comprises a display device, and the at least one transferred input/output function comprises a display function of the telephone.

35. The system of claim 28, wherein the alternate access device comprises a keypad, and the at least one transferred input/output function comprises a keypad function of the telephone.

36. The system of claim 28, wherein the alternate access device comprises a speaker, and the at least one transferred input/output function comprises an audio function of the telephone.

37. The system of claim 28, wherein the alternate access device comprises a microphone, and the at least one transferred input/output function comprises a microphone function of the telephone.

38. The system of claim 28, wherein the alternate access device comprises a video camera, and the at least one transferred input/output function comprises a video camera function of the telephone.

39. The system of claim 28, wherein the target device comprises an internet protocol phone.

40. The system of claim 28, wherein the target device comprises a telephone server.

41. The system of claim 40, wherein the telephone server is operable to establish a third-communication link with a remote telephone.

42. The system of claim 28, wherein the target device comprises a gateway.

43. The system of claim 42, wherein the gateway is operable to establish a third communication link with a remote telephone.

44. The system of claim 28, wherein the telephone includes an input device and is operable to associate itself with the alternate access device responsive to receiving an address of the alternate access device on the input device.

45. The system of claim 28, wherein the alternate access device includes an input device and is operable to associate itself with the telephone responsive to receiving an address of the telephone on the input device.

46. The system of claim 45, wherein the telephone is operable to provide a confirmation code and the alternate access device is operable to receive the confirmation code on the input device prior to associating itself with the telephone.

47. The system of claim 28, wherein at least one of the telephone and the alternate access device is operable to verify a proximity of the telephone and the alternate access device.

48. The system of claim 28, wherein the telephone is operable to provide an indication responsive to transferring the at least one input/output function to the alternate access device.

49. The system of claim 48, wherein the indication comprises at least one of a visual indication and an audio indication.

50. The system of claim 28, wherein the telephone has an access rights profile, and the alternate access device is restricted to the access rights profile of the telephone.

51. The system of claim 28, wherein the target device comprises a virtual telephone.

52. The system of claim 51, wherein the virtual telephone is operable to establish a third communication link with a remote telephone.

53. The system of claim 28, wherein the telephone is further operable to communicate data associated with the transferred input/output function over the first communication link.

54. The system of claim 28, wherein the telephone is operable to communicate over the first communication link using a first protocol, and the alternate access device is operable to communicate over the second communication link using a second protocol different than the first protocol.

55. A system, comprising:
means for establishing a first communication link between a telephone having a plurality of input/output functions and a target device;
means for associating an alternate access device with the telephone;
means for transferring at least one of the input/output functions to the alternate access device;
means for establishing a second communication link between the target device and the alternate access device;
means for communicating data associated with input/output functions not transferred to the alternate access device over the first communication link; and
means for communicating data associated with the transferred input/output function over the second communication link.
